(19) United States
(12) Patent Application Publication
(10) Pub. No.: US 2019/0124524 A1
(43) Pub. Date: Apr. 25, 2019

(54) SYSTEM AND METHOD FOR EVENT SYNCHRONIZATION IN WIRELESS NETWORKS

(71) Applicant: Nokia Solutions and Networks OY, Espoo (FI)

(72) Inventor: Eamonn GORMLEY, Bothell, WA (US)

(21) Appl. No.: 16/090,147

(22) PCT Filed: Sep. 13, 2016
(86) PCT No.: PCT/US16/51556

§ 371 Date: Sep. 28, 2018

Related U.S. Application Data
(63) Continuation of application No. 15/085,933, filed on Mar. 30, 2016, now abandoned.
(60) Provisional application No. 62/140,195, filed on Mar. 30, 2015.
(60) Provisional application No. 62/140,208, filed on Mar. 30, 2015.
(60) Provisional application No. 62/140,212, filed on Mar. 30, 2015.
(60) Provisional application No. 62/140,217, filed on Mar. 30, 2015.

(51) Int. Cl. H04W 24/02

(52) U.S. Cl. CPC H04W 24/02; H04W 24/04

(57) ABSTRACT

A method for synchronizing times across a plurality of base stations in a frequency division duplexing (FDD) wireless communications network includes receiving, at a plurality of base stations in the network, at least one timing reference signal associated with an external time reference, comparing the timing reference signal to internal clock times of the plurality of base stations, receiving an instruction to perform an activity at a time relative to Coordinated Universal Time (UTC), and performing the activity, by the plurality of base stations, at the time relative to UTC.

### CROSS-REFERENCES TO RELATED APPLICATIONS

The present disclosure claims priority to U.S. application Ser. No. 15/085,933, filed Mar. 30, 2016, which claims priority from U.S. Provisional Application No. 62/140,217, filed Mar. 30, 2015, each of which are incorporated by reference herein for all purposes.

### BACKGROUND

Cellular radio networks generally have strict requirements for the accuracy of the transmit frequencies on which the networks operate. For example, the radio interfaces of GSM and UMTS base stations have a frequency accuracy requirement of ±50 ppb (parts per billion).

Cellular radio networks may or may not have such strict requirements for the relative timing from base station to base station. In general, Time Division Duplexing (TDD) networks require synchronization of airlink timing so that the downlink transmissions don't overlap with the uplink transmissions in time. In the case of UMTS TDD systems, the timing alignment of neighboring base stations should be within 2.5 μs.

Frequency Division Duplexing (FDD) networks usually have no such requirement for their timing accuracy. In particular, GSM and UMTS FDD networks do not have specified synchronization requirements. In such networks, the frame timing at one base station has no relation to the frame timing at other base stations.

One notable exception to the lack of timing synchronization in FDD cellular communication networks is the CDMA2000 base station specifications. CDMA2000 is a FDD technology. CDMA2000 base stations are required to be aligned to CDMA system time (synchronous to Coordinated Universal Time (UTC) and use the same time origin as GPS time). As specified in CDMA document 3GPP2 C.S0024-B, “cdma2000 High Rate Packet Data Air Interface Specification,” the timing error for CDMA2000 base stations should be less than 3 μs and shall be less than 10 μs.

Wireless communication systems that do not synchronize timing to an external timing reference are not capable of performing activities that rely on coordinating activities between multiple base stations.

### FIELD OF TECHNOLOGY

Embodiments of the present disclosure are directed to wireless communications, and to a time-synchronized FDD communication system and method of synchronizing an FDD system.

### BRIEF SUMMARY

Embodiments of the present disclosure relate to a method and system for establishing a common time base across a network of cellular base stations.

In an embodiment, a method for synchronizing times across a plurality of base stations in a frequency division duplexing (FDD) wireless communications network includes receiving, at a plurality of base stations in the network, at least one timing reference signal associated with an external time reference, comparing the timing reference signal to an internal clock time of the plurality of base stations, receiving an instruction to perform an activity at a time relative to Coordinated Universal Time (UTC), and performing the activity, by the plurality of base stations, at the time relative to UTC.

In an embodiment, the plurality of base stations wirelessly communicate with mobile devices using at least one of Long Term Evolution (LTE), Global System for Mobile (GSM) and Universal Mobile Telecommunications System (UMTS) communication technologies. The timing reference signal may be a Network Timing Protocol (NTP) The internal clock times of the base stations may be independent times that are specific to respective base stations without regard to any external reference time.

In an embodiment, the activity instructs the base stations to hold coordinated parameters for at least 10 milliseconds. Each base station of the plurality of base stations may receive a plurality of timing reference signals from a plurality of time servers. The external time reference may be a satellite-based time reference or an atomic clock based time reference. The plurality of base stations may be femtocell base stations in a cellular network.

### BRIEF DESCRIPTION OF THE DRAWINGS

FIG. 1 illustrates a wireless communications system according to an embodiment.

FIG. 2 illustrates a network resource controller according to an embodiment.

FIG. 3 illustrates a wireless network in which base stations are time synchronized to the GPS satellite constellation.

FIG. 4 illustrates a wireless network in which base stations are not time synchronized.

FIG. 5 illustrates a wireless network in which base stations are time synchronized to a common reference source.

FIG. 6 illustrates a process for time synchronization in a wireless communications network.

FIG. 7 illustrates a wireless communications system with time synchronized base stations according to an embodiment.

FIG. 8 illustrates a wireless communications system according to an embodiment.

### DETAILED DESCRIPTION

A detailed description of embodiments is provided below along with accompanying figures. The scope of this disclosure is limited only by the claims and encompasses numerous alternatives, modifications and equivalents. Although steps of various processes are presented in a particular order, embodiments are not necessarily limited to being performed in the listed order. In some embodiments, certain operations may be performed simultaneously, in an order other than the described order, or not performed at all.

Numerous specific details are set forth in the following description in order to provide a thorough understanding. These details are provided for the purpose of example and embodiments may be practiced according to the claims without some or all of these specific details. For the purpose of clarity, technical material that is known in the technical fields related to this disclosure has not been described in detail so that the disclosure is not unnecessarily obscured.

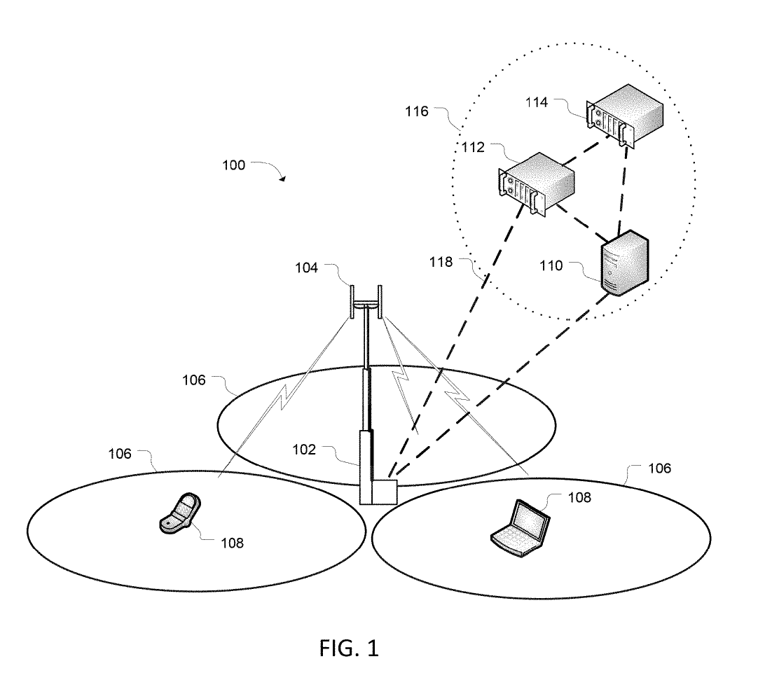

FIG. 1 illustrates a networked communications system 100 according to an embodiment of this disclosure. System 100 may include one or more base stations 102, each of which are equipped with one or more antennas 104. Each of the antennas 104 may provide wireless communication for user equipment (UE) 108 in one or more cells 106. Base stations 102 have antennas 104 that are receive antennas which may be referred to as receivers, and transmit antennas, which may be referred to as transmitters. As used herein, the term “base station” refers to a wireless communications station provided in a location and serves as a hub of a wireless network. For example, in LTE, a base station may be an eNodeB. The base stations may provide service for macrocells, microcells, picocells, or femtocells. In other embodiments, the base station may be an access point in a Wi-Fi network.

The one or more UE 108 may include cell phone devices, mobile hotspots, laptop computers, handheld gaming units, electronic book devices and tablet PCs, and any other type of common portable wireless computing device that may be provided with wireless communications service by a base station 102. In an embodiment, any of the UE 108 may be associated with any combination of common mobile computing devices (e.g., laptop computers, tablet computers, cellular phones, mobile hotspots, handheld gaming units, electronic book devices, personal music players, video recorders, etc.), having wireless communications capabilities employing any common wireless data communications technology, including, but not limited to: GSM, UMTS, 3GPP LTE, LTE Advanced, WiMAX, etc.

The system 100 may include a backhaul portion 116 that can facilitate distributed network communications between backhaul equipment or network controller devices 110, 112 and 114 and the one or more base station 102. As would be understood by those skilled in the art, in most digital communications networks, the backhaul portion of the network may include intermediate links 118 between a backbone of the network which are generally wire line, and sub networks or base stations located at the periphery of the network. For example, cellular mobile devices (e.g., UE 108) communicating with one or more base station 102 may constitute a local sub network. The network connection between any of the base stations 102 and the rest of the world may initiate with a link to the backhaul portion of a provider's communications network (e.g., via a point of presence).

In an embodiment, the backhaul portion 116 of the system 100 of FIG. 1 may employ any of the following common communications technologies: optical fiber, coaxial cable, twisted pair cable, Ethernet cable, and power-line cable, along with any other wireless communication technology known in the art. In context with various embodiments, it should be understood that wireless communications coverage associated with various data communication technologies (e.g., base station 102) typically vary between different service provider networks based on the type of network and the system infrastructure deployed within a particular region of a network (e.g., differences between GSM, UMTS, LTE, LTE Advanced, and WiMAX based networks and the technologies deployed in each network type).

Any of the network controller devices 110, 112 and 114 may be a dedicated Network Resource Controller (NRC) that is provided separately from the base stations or provided at the base station. Any of the network controller devices 110, 112 and 114 may be a non-dedicated device that provides NRC functionality. In another embodiment, an NRC is a Self-Organizing Network (SON) server. In an embodiment, any of the network controller devices 110, 112 and 114 and/or one or more base stations 102 may function independently or collaboratively to implement processes associated with various embodiments of the present disclosure.

In accordance with a standard GSM network, any of the network controller devices 110, 112 and 114 (which may be NRC devices or other devices optionally having NRC functionality) may be associated with a base station controller (BSC), a mobile switching center (MSC), a data scheduler, or any other common service provider control device known in the art, such as a radio resource manager (RRM). In accordance with a standard UNITS network, any of the network controller devices 110, 112 and 114 (optionally having NRC functionality) may be associated with a RNC, a serving GPRS support node (SGSN), or any other common network controller device known in the art, such as an RRM. In accordance with a standard LTE network, any of the network controller devices 110, 112 and 114 (optionally having NRC functionality) may be associated with an eNodeB base station, a mobility management entity (MME), or any other common network controller device known in the art, such as an RRM.

In an embodiment, any of the network controller devices 110, 112 and 114, the base stations 102, as well as any of the UE 108 may be configured to run any well-known operating system. Any of the network controller devices 110, 112 and 114 or any of the base stations 102 may employ any number of common server, desktop, laptop, and personal computing devices.

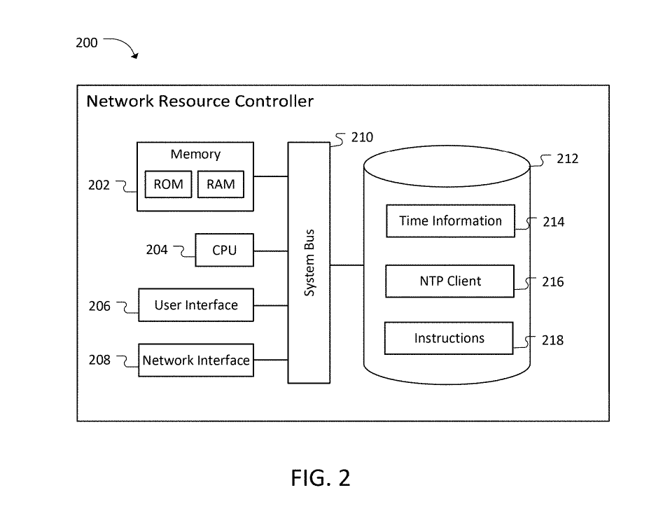

FIG. 2 illustrates a block diagram of an NRC 200 that may be representative of any of the network controller devices 110, 112 and 114. Accordingly, NRC 200 may be representative of a Network Management Server (NMS), an Element Management Server (EMS), a Mobility Management Entity (MME), a SON server, etc. The NRC 200 has one or more processor devices including a CPU 204.

The CPU 204 is responsible for executing computer programs stored on volatile (RAM) and nonvolatile (ROM) memories 202 and a storage device 212 (e.g., HDD or SSD). In some embodiments, storage device 212 may store program instructions as logic hardware such as an ASIC or FPGA. Storage device 212 may store, for example, time information 214, an NTP client 216, and instructions 218.

The NRC 200 may also include a user interface 206 that allows an administrator to interact with the NRC's software and hardware resources and to display the performance and operation of the system 100. In addition, the NRC 200 may include a network interface 208 for communicating with other components in the networked computer system, and a system bus 210 that facilitates data communications between the hardware resources of the NRC 200.

In addition to the network controller devices 110, 112 and 114, the NRC 200 may be used to implement other types of computer devices, such as an antenna controller, an RF planning engine, a core network element, a database system, or the like. Based on the functionality provided by an NRC, the storage device of such a computer serves as a repository for software and database thereto.

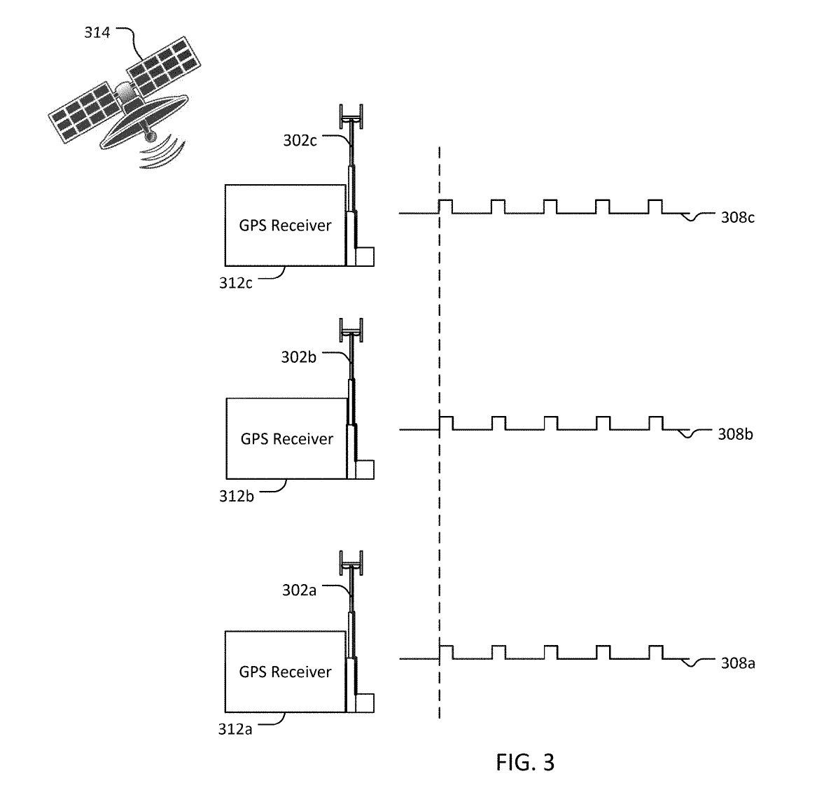

FIG. 3 illustrates a wireless system that has tightly coordinated airlink timing. In the system of FIG. 3, three base stations 302a, 302b and 302c are base stations in the same wireless network. Each of the base stations 302a, 302b and 302c has a respective GPS receiver 312a, 312b and 312c that is wirelessly coupled to a GPS satellite 314 constellation. Therefore, airlink timing 308a, 308b and 308c associated with the respective base stations 302 can be tightly synchronized with one another. The tight synchronization between the timing 308 is represented by the alignment of a leading edge in the timing pulses to a dashed line that represents a single point in time.

The GPS receiver 312 is one example of base station hardware for synchronizing airlink timing to a common time reference. When a GPS receiver 312 is used, it passes timing information to the base station 302 over a standard timing interface (e.g., GPS Pulse Per Second, (PPS)). Another example of such base station hardware is a timing module that extracts timing passed over backhaul connections (e.g., T1, E1, Ethernet).

Hardware that is dedicated to airlink time synchronization can provide a very accurate timing signal to each base station 302, allowing time synchronization to within a few microseconds. The primary drawback with using specific hardware modules to establish a tuning reference is the cost. Additionally, base stations that have already been deployed in the field may not have a provision for accepting an external timing signal. In such networks, hardware modules cannot be used to establish a common timing reference across the base stations in the network.

Time Division Duplexing (TDD) systems rely on tight time coordination to maintain a clean division between uplink and downlink times, so tightly synchronized signals 308 may exist in a UMTS TDD or CDMA2000 network of base stations.

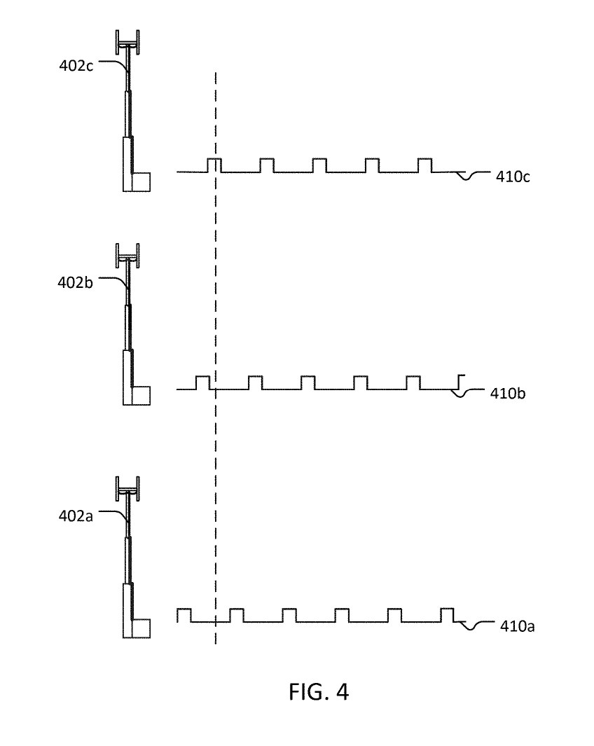

In contrast, FIG. 4 shows a wireless communications system including base stations 402a, 402b and 402c that are not tightly synchronized to a time reference. None of the base stations 402 are equipped with a GPS receiver. Accordingly, signals 410a, 410b and 410c are not aligned with one another, which is represented by the lack of alignment to the dashed line in FIG. 4 that represents a single point in time.

Rather, the signals are effectively randomly aligned with respect to one another in the time dimension. Such a system may be representative of, for example, a GSM or UMTS or LTE FDD network of base stations.

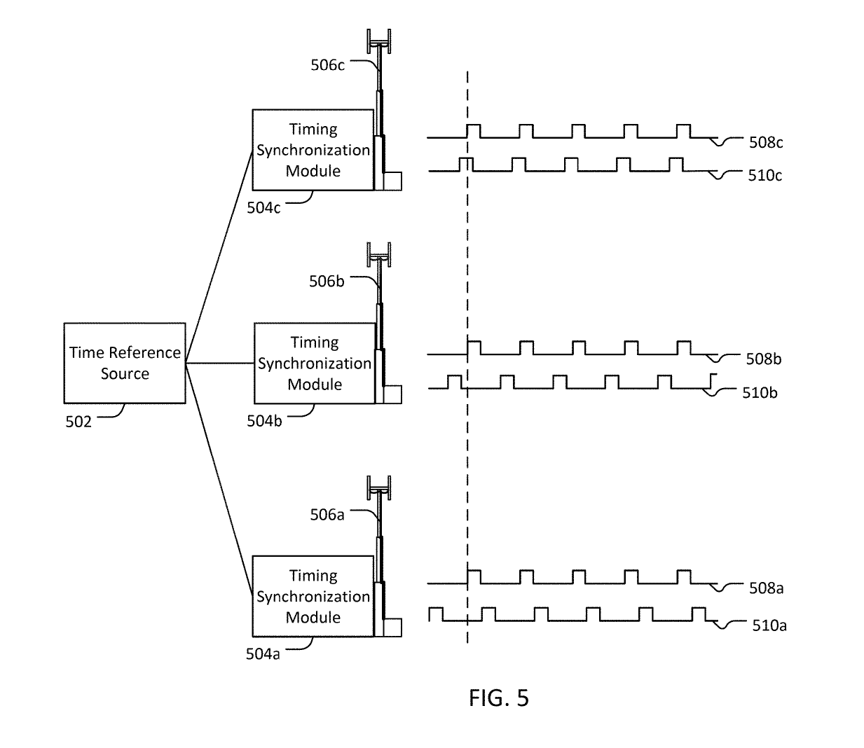

FIG. 5 shows three base stations 506a, 506b and 506c, each respectively coupled to tuning modules 504a, 504b and 504c. The timing modules 504 are each independently coupled to a remote time reference source 502. As a result, the base stations 506 can establish a local timing reference that may be tightly synchronized in time with respect to time reference source 502, which effectively synchronizes the base stations to one another.

The timing modules 504 may include instructions for performing processes of this disclosure that are recorded on a computer readable medium of the base stations. In an embodiment, the hardware component of the timing modules 504 is pre-existing computer hardware of the base stations 506. The base stations 506 may be base stations in a wireless FDD network that are not equipped with GPS receivers.

Without the time reference source 502 and the timing synchronization modules 504a, 504b and 504c, the base stations 506 may transmit and/or receive unsynchronized signals 510a, 510b and 510c, respectively. However, when the time synchronization modules 504 are coupled between a time reference source 502 and a base station 506, the base stations can synchronize to that time reference source.

For networks that have timing alignment requirements, it is relatively straightforward to schedule future events to occur on or about the same time throughout the network. An example of such a scheduled event is for automated interference detection during coordinated listening times. In such a system, all base stations are instructed to establish a simultaneous quiet time, where the mobile devices and/or base stations in the network are instructed not to transmit. Another example of a scheduled event is a synchronized network parameter update, where the network parameter is scheduled to take effect at each base station at the same time. Examples of such parameters are transmit power, or a handover offset parameter.

For cellular networks where the base stations are not aligned in time to a common timing source, it is not feasible to schedule such synchronized events based on the local frame timing alone. Therefore, in order to enable synchronized events in such a network, it is important to establish a common timing reference across all the base stations.

An alternate to hardware timing synchronization is to use software time synchronization. One protocol that is commonly used over packet switched Internet Protocol (IP) links is the Network Timing Protocol (NTP). Depending on the latency variations over the packet data links in a network, NTP can establish a timing reference to within a few milliseconds or less. This protocol is described in IETF RFC 1305 and RFC 5905. A less complex implementation of NTP also exists, known as the Simple Network Timing Protocol (SNTP), described in RFC 4330. SNTP is described as a subset of NTP. Thus, in this disclosure, the term “NTP,” may encompass NTP-based technologies including SNTP and other software that uses portions of NTP's code to establish system time for network nodes.

Another protocol that spans the hardware and software domains is the Precision Timing Protocol (PTP), standardized as IEEE 1588. PTP can achieve sub-microsecond timing alignment. However, it makes use of hardware timestamps applied at the physical layer at each end of a connection—hence, the base station Ethernet interfaces would already have to support such time stamping, which is generally not the case. PTP is generally intended for deployment over a local area network and may not be applicable over the backhaul networks connecting multiple base stations.

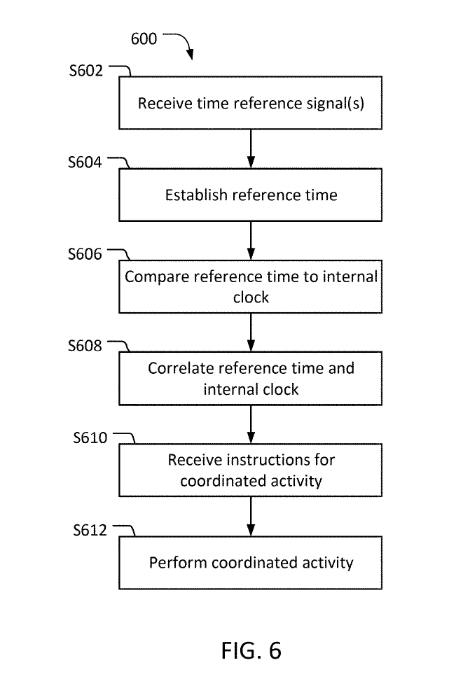

FIG. 6 illustrates an embodiment of a process 600 for time synchronization in a wireless communications network. According to process 600, one or more time reference signal is received by a base station at S602. Process 600 may be performed by one or more base station.

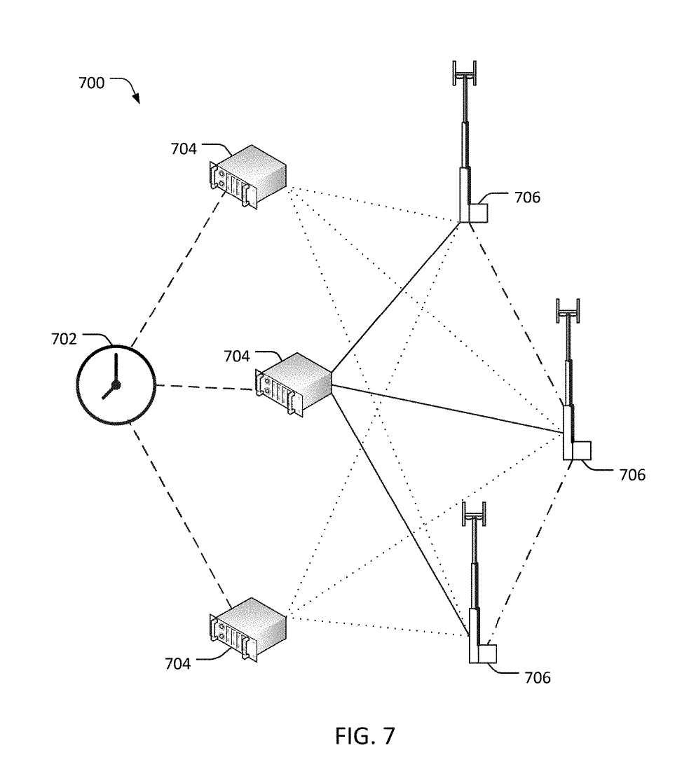

FIG. 7 illustrates a wireless communications system 700 with time synchronized base stations according to an embodiment. The communications system includes a time reference source 702 coupled to a plurality of time servers 704, which are in turn coupled to a plurality of base stations 706. The time reference may be relative to Coordinated Universal Time (UTC), which is the primary global time standard.

In various embodiments, the time reference source 702 may be a GPS satellite or an atomic clock. The time reference source 702 transmits timing information to one or more time server 704. The time servers 704 may be standalone servers that are dedicated to the purpose of distributing time information from the time source 702 to other networked entities.

In another embodiment, a time server may be integrated with a Network Resource Controller such as NRC 200, which is coupled to a backhaul of a wireless network. In such an embodiment, hardware such as a GPS receiver or NIST modem may be installed at the NRC, which in turn can distribute timing information to network nodes.

In other embodiments, the time servers 704 are public or government servers. Such servers may be coupled to the Internet for the purpose of distributing time information from the time source 702.

Although FIG. 7 shows the base stations receiving timing information directly from a plurality of time servers 704, other embodiments are possible. For example, the base stations may be coupled to the time source 702 through a time server 704 as well as additional computer entities. In some embodiments, the base stations receive timing information from a plurality of computing devices, which may be time servers 704, or otherwise coupled to time servers 704. In addition, the base stations could synchronize to one another through X2 or other interfaces to improve or confirm tight synchronization.

In an embodiment, the time servers 704 are Stratum 1 computers of an NTP system, while the time source 702 is a Stratum 0 device. In such an embodiment, the base stations may receive time reference signals at S602 that originated at the time source 702, and pass through one or more Stratum before arriving at the base station 706. In an NTP system, the timing accuracy at base stations 706 can be increased by increasing the number of signals that are received at S602. Accordingly, the base stations 706 may receive multiple signals from multiple time servers 704 at S602.

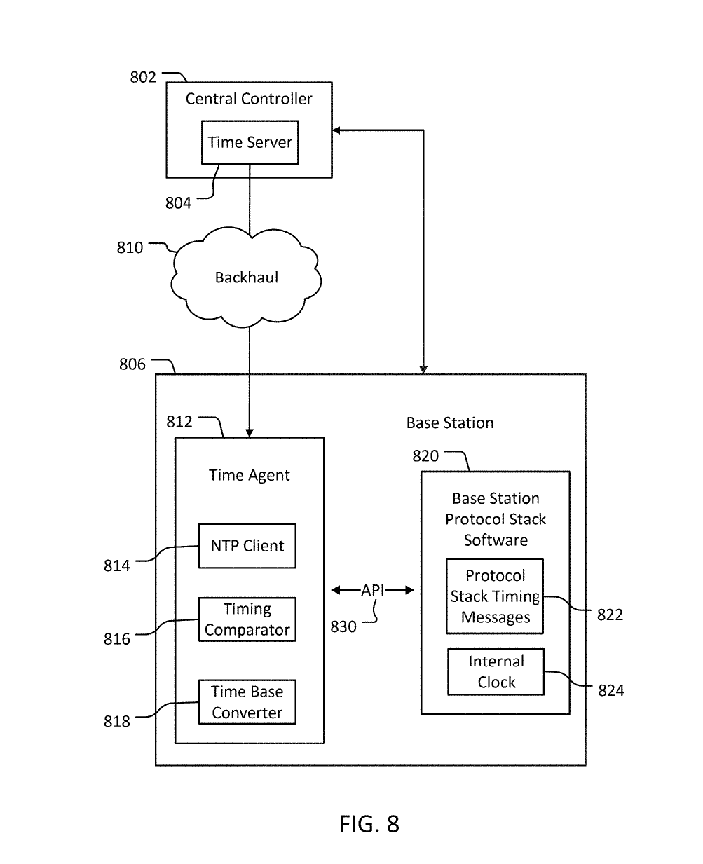

FIG. 8 illustrates an embodiment of a wireless communications system in which a time server 804 is located within a central controller device 802. The central controller device 802 may be a central network controller such as an MME or a SON server. The central controller 802 is in communication with a time agent 812 at a base station 806 through backhaul elements 810.

The time agent 812 contains an NTP client 814. The time agent 812 uses NTP to establish a time base reference with a time server 804 which includes NTP software. In some embodiments, the centralized controller 802 and time server 804 are implemented on different machines.

The base station 806 establishes a reference time based on time information received from the time server 804 at S604. The reference time may be established by a time agent 812 deployed at base station 806. The time agent 812 may include software that is coupled between the base station protocol stack software 820 and central controller 802. The software agent may be supplied by a third party to the base station software vendor. The base station protocol stack software 820 may encompass all software apart from software associated with the time agent 812 that resides at the base station 806.

In an embodiment, the time base established at S604 is not shared with other software or hardware at the base station 806 and is known only to the time agent 812. While NTP time synchronization may not facilitate synchronization to the same degree of alignment as a GPS receiver, it can be used in cases where it is acceptable that the events at each base station 806 are synchronized to within a few milliseconds of each other.

In an embodiment, it is not necessary to change the time base used by the internal clock 824 at each base station 806. Instead, a translation process may be used to convert between the common time base established at each of the time agents in the network and the local time base used by the internal clock 824 at each base station.

The time agent 812 also communicates with the existing base station protocol stack 820 over an Application Programming Interface (API) 830. The existing base station protocol stack 820 provides periodic timestamps from internal clock 824 to the time agent 812 over the API 830. In this manner, the time agent 812 learns the time base used by the base station protocol stack software 820.

A reference time established by the time agent 812 based on time information from one or more time server 804 is compared to timing from the internal clock 824 of the base station by a timing comparator 816 at S606. In an embodiment, time agent 812 compares relative timing between the time base established by the time agent 812 with the time server 804, and the time base of internal clock 824 communicated by the base station protocol stack 820 over the software agent API 830.

The output of the timing comparator is transmitted to a time base converter 818, and the reference time maintained by the time agent 812 is correlated with the base station clock timing at S608. For example, the timing comparator 816 may establish an offset between the reference time maintained by time agent 812 and the internal clock 824. The time base converter 818 converts timing information from one time base to another time base. Accordingly, times of the internal clock 824 of base station 806 may be indexed to a reference time maintained by time agent 812, so that protocol stack timing messages 822 can be linked to UTC time through the time agent.

Instructions for performing a time-coordinated activity are received at S610. The instructions may be received from a central controller entity, or NRC 200, coupled to the base station 806 through backhaul 810.

A centralized controller 802 informs the time agent 812 when to schedule an event. Although FIG. 8 shows the central controller 802 as being the controller that houses the time server 804, in other embodiments, the instruction for the coordinated activity may be received from some other central network controller.

The centralized controller 802 schedules the event to occur at or about the same time at multiple base stations 806 by sending messages to the base stations informing them all of the time at which the event is to occur. The time indicated in the message sent by the centralized controller 802 is relative to the time of the reference time source 702, which is the same as the time base established at the time agents 812 at each base station 806.

When the time agent 812 at each base station 806 receives the message to perform a coordinated activity from the centralized controller 802, it converts the event time contained in the message from the synchronized time base to the time base used by the base station protocol stack 820 using the time base converter 818. Thus, even though the time base of the internal clock 824 at each base station is different, each of them will schedule the event to occur at the same absolute time. Accordingly, when the coordinated activity is performed at S612, the activity is performed at the same time by all such time-synchronized base stations, even when the base stations are FDD base stations that are not equipped with dedicated time synchronization hardware.

Because NTP may only synchronize base stations to within a few milliseconds of one another, it is advantageous for the synchronized activities performed at S612 to be tolerant of such timing variance. Some activities, such as coordinated power and phase scheduling, have cycles that last for tens or hundreds of milliseconds. Such activities would benefit from embodiments of this disclosure even when timing is not synchronized to the level of TDD networks. Accordingly, in an embodiment, the synchronized activity may include an event, such as a series of blank (quiet) frames or holding a particular phase or power level, that lasts for longer than 10 milliseconds. In another embodiment, the event may be longer than 50 or 100 milliseconds.

The synchronized activity performed at S612 may be determined by a network operator. As communication networks evolve, increasingly sophisticated tools are available to network operators to optimize performance of wireless communications networks. A non-limiting list of some of the coordinated activities that are made possible by embodiments of the present disclosure includes beamforming between multiple base stations, phase coordination as described, for example, by U.S. Pat. No. 8,412,246, load balancing, coordinating quiet times, interference detection, power level coordination, etc.

Embodiments of this disclosure provide numerous advantages to conventional wireless communications technologies. Embodiments may be implemented using pre-existing hardware at base stations, without incurring the time and expense for installing dedicated location hardware. Some embodiments may be applied to indoor base stations, where it is difficult to receive a GPS signal, and where dedicated timing hardware costs can be prohibitive. NTP can be implemented over the Internet, which is generally available to indoor base stations.

What is claimed is:

1. A method for synchronizing times across a plurality of base stations in a frequency division duplexing (FDD) wireless communications network, the method comprising:
receiving, at a plurality of base stations in the network, at least one timing reference signal associated with an external time reference;
comparing the timing reference signal to internal clock times of the plurality of base stations;
receiving an instruction to perform an activity at a time relative to Coordinated Universal Time (UTC); and
performing the activity, by the plurality of base stations, at the time relative to UTC.

2. The method of claim 1, wherein the plurality of base stations wirelessly communicate with mobile devices using at least one of Long Term Evolution (LTE), Global System for Mobile (GSM) and Universal Mobile Telecommunications System (UMTS) communication technologies.

3. The method of claim 1, wherein the timing reference signal is a Network Timing Protocol (NTP) signal.

4. The method of claim 1, wherein the internal clock times of the base stations are independent times that are specific to respective base stations without regard to any external reference time.

5. The method of claim 1, wherein the activity instructs the base stations to hold coordinated parameters for at least 10 milliseconds.

6. The method of claim 1, wherein each base station of the plurality of base stations receives a plurality of timing reference signals from a plurality of time servers.

7. The method of claim 1, wherein the external time reference is a satellite-based time reference or an atomic clock based time reference.

8. The method of claim 1, wherein the plurality of base stations are femtocell base stations in a cellular network.

9. The method of claim 8, wherein the plurality of base stations wirelessly communicate with mobile devices using at least one of Long Term Evolution (LTE), Global System for Mobile (GSM) and Universal Mobile Telecommunications System (UMTS) communication technologies.

10. The method of claim 9, wherein the internal clock times of the base stations are independent times that are specific to respective base stations without regard to any external reference time.

11. A wireless communication system comprising:
a plurality of base stations;
one or more processor; and
one or more non-transitory computer readable medium with computer-executable instructions stored thereon which, when executed by the one or more processor, perform the following operations:
receiving, at the plurality of base stations, at least one timing reference signal associated with an external time reference;
comparing the timing reference signal to internal clock times of the plurality of base stations;
receiving an instruction to perform an activity at a time relative to Coordinated Universal Time (UTC); and
performing the activity, by the plurality of base stations, at the time relative to UTC.

12. The system of claim 11, wherein the plurality of base stations wirelessly communicate with mobile devices using at least one of Long Term Evolution (LTE), Global System for Mobile (GSM) and Universal Mobile Telecommunications System (UMTS) communication technologies.

13. The system of claim 11, wherein the timing reference signal is a Network Timing Protocol (NTP) signal.

14. The system of claim 11, wherein the internal clock times of the base stations are independent times that are specific to respective base stations without regard to any external reference time.

15. The system of claim 11, wherein the activity instructs the base stations to hold coordinated parameters for at least 10 milliseconds.

16. The system of claim 11, wherein each base station of the plurality of base stations receives a plurality of timing reference signals from a plurality of time servers.

17. The system of claim 11, wherein the external time reference is a satellite-based time reference or an atomic clock based time reference.

18. The system of claim 11, wherein the plurality of base stations are femtocell base stations in a cellular network.

19. The system of claim 18, wherein the plurality of base stations wirelessly communicate with mobile devices using at least one of Long Term Evolution (LTE), Global System for Mobile (GSM) and Universal Mobile Telecommunications System (UMTS) communication technologies.

20. The system of claim 19, wherein the internal clock times of the base stations are independent times that are specific to respective base stations without regard to any external reference time.
